(19) United States
(12) Patent Application Publication
(10) Pub. No.: US 2025/0306985 A1
(43) Pub. Date: Oct. 2, 2025

(54) PARALLIZATION OF NETWORK COMMUNICATIONS

(71) Applicant: NVIDIA Corporation, Santa Clara, CA (US)

(72) Inventor: Elena Agostini, Rome (IT)

(21) Appl. No.: 18/618,308

(22) Filed: Mar. 27, 2024

(51) Int. Cl. G06F 9/48

(52) U.S. Cl. CPC G06F 9/4881

(57) ABSTRACT

Embodiments are directed to parallel processing of network communications on devices supporting a high degree of parallelization, such as a Graphics processing unit (GPU). Generally speaking, embodiments are directed to an inline packet processing pipeline to receive packets in GPU memory without staging copies through Central Processing Unit (CPU) memory, process the received packets in parallel with one or more kernels of the GPU, and then run inference, evaluate, or send over the network the result of the calculation. In this way, the highly parallel nature of the GPU can be leveraged to process network communications without involving other elements of the system, such as the CPU, which can be quickly consumed with processing network communications to the detriment of other processes.

### FIELD OF THE DISCLOSURE

The present disclosure is generally directed to processing of network communications and more particularly to parallel processing of network communications on devices supporting a high degree of parallelization, such as a Graphics processing unit (GPU).

### BACKGROUND

Real-time Graphics processing unit (GPU) processing of network traffic packets is a technique useful for application domains involving signal processing, network security, information gathering, input reconstruction, and more. These applications take a Central Processing Unit (CPU)-centric approach involving the CPU in the critical path to coordinate the Network Interface Controller (NIC) for receiving packets in the GPU memory and notifying a packet-processing kernel waiting on the GPU for a new set of packets. In lower-power platforms, the CPU can easily become a bottleneck, masking GPU value. Hence, there is a need in the art for improved methods and systems for processing of network communications.

### BRIEF SUMMARY

Embodiments of the present disclosure are directed to parallel processing of network communications on devices supporting a high degree of parallelization, such as a Graphics processing unit (GPU). Generally speaking, embodiments of the present disclosure are directed to an inline packet processing pipeline to receive packets in GPU memory without staging copies through Central Processing Unit (CPU) memory, process the received packets in parallel with one or more kernels of the GPU, and then run inference, evaluate, or send over the network the result of the calculation. In this way, the highly parallel nature of the GPU can be leveraged to process network communications without involving other elements of the system, such as the CPU, which can be quickly consumed with processing network communications to the detriment of other processes.

According to one embodiment, a Central Processing Unit (CPU) can comprise a control circuit controlling operation of the CPU. The control circuit can cause the CPU to receive, from a Network Interface Card (NIC), through a communication network, a plurality of data packets, For example, the communication network comprises an Ethernet network. The control circuit can further cause the CPU to post, in a Receive Queue (RQ) of a Graphics Processing Unity (GPU), a plurality of Work Queue Entries (WQEs), each WQE of the plurality of WQEs corresponding to a packet of the received plurality of packets, and poll, in parallel, a plurality of Completion Queue Entries (CQEs) from a Completion Queue (CQ) of the GPU, each CQE of the plurality of CQEs corresponding to a WQE of the plurality of WQEs.

The memory of the GPU can comprise a pre-allocated portion of memory mapped to the NIC. The pre-allocated portion of memory mapped to the NIC can be split into a plurality of strides of Maximum Transmission Unit (MTU) fixed size. Each WQE of the plurality of WQEs can reference a different stride of the plurality of strides.

Posting the plurality of WQEs in the RQ of the GPU can comprise creating the plurality of WQEs in the RQ of the GPU based on the received plurality of packets, issuing a memory barrier instruction for a doorbell record of the NIC, and updating the doorbell record of the NIC based on the created plurality of WQEs.

Polling, in parallel, the plurality of CQEs from the CQ of the GPU can comprise polling a plurality of CQEs from each of a plurality of executing threads. More specifically, polling, in parallel, the plurality of CQEs from the CQ of the GPU can comprise locking the CQ of the GPU and storing data from each CQE of the plurality of CQEs to memory of the GPU. Storing data from each CQE of the plurality of CQEs to memory of the GPU can comprise reading an index for the plurality of CQEs, checking data of a CQE of the plurality of CQEs corresponding to the index for errors, in response to the data of the CQE of the plurality of CQEs corresponding to the index being error free, storing the data of the CQE of the plurality of CQEs corresponding to the index in the memory of the GPU, and incrementing the index of the plurality of CQEs. Polling, the plurality of CQEs from the CQ of the GPU can further comprise issuing a memory barrier instruction for a doorbell record of the NIC, updating the doorbell record of the NIC, and unlocking the CQ of the GPU.

According to another embodiment, a system can comprise a communication network, a NIC coupled with the communications network, a GPU coupled with the network, and a CPU coupled with the communications network. For example, the communication network can comprise an Ethernet network. The CPU can comprise a control circuit controlling operation of the CPU. The control circuit can cause the CPU to receive, from the NIC, through the communication network, a plurality of data packets, post in a RQ of the GPU a plurality of WQEs, each WQE of the plurality of WQEs corresponding to a packet of the received plurality of packets, and poll, in parallel, a plurality of CQEs from a CQ of the GPU, each CQE of the plurality of CQEs corresponding to a WQE of the plurality of WQEs.

The memory of the GPU can comprise a pre-allocated portion of memory mapped to the NIC. The pre-allocated portion of memory mapped to the NIC can be split into a plurality of strides of MTU fixed size. Each WQE of the plurality of WQEs can reference a different stride of the plurality of strides.

Posting the plurality of WQEs in the RQ of the GPU can comprise creating the plurality of WQEs in the RQ of the GPU based on the received plurality of packets, issuing a memory barrier instruction for a doorbell record of the NIC, and updating the doorbell record of the NIC based on the created plurality of WQEs.

Polling, in parallel, the plurality of CQEs from the CQ of the GPU can comprise polling a plurality of CQEs from each of a plurality of executing threads. More specifically, polling, in parallel, the plurality of CQEs from the CQ of the GPU can comprise locking the CQ of the GPU and storing data from each CQE of the plurality of CQEs to memory of the GPU. Storing data from each CQE of the plurality of CQEs to memory of the GPU can comprise reading an index for the plurality of CQEs, checking data of a CQE of the plurality of CQEs corresponding to the index for errors, in response to the data of the CQE of the plurality of CQEs corresponding to the index being error free, storing the data of the CQE of the plurality of CQEs corresponding to the index in the memory of the GPU, and incrementing the index of the plurality of CQEs. Polling, the plurality of CQEs from the CQ of the GPU can further comprise issuing a memory barrier instruction for a doorbell record of the NIC, updating the doorbell record of the NIC, and unlocking the CQ of the GPU.

According to yet another embodiment, a method for parallel processing of network communications can comprise receiving, by a CPU, from a NIC, through an Ethernet network, a plurality of data packets and posting, in a RQ of a GPU, a plurality of WQEs. Each WQE of the plurality of WQEs can correspond to a packet of the received plurality of packets. A plurality of CQEs can be polled in parallel from a CQ of the GPU. Each CQE of the plurality of CQEs can correspond to a WQE of the plurality of WQEs. Polling, in parallel, the plurality of CQEs from the CQ of the GPU can comprise polling a plurality of CQEs from each of a plurality of executing threads.

The memory of the GPU can comprise a pre-allocated portion of memory mapped to the NIC. The pre-allocated portion of memory mapped to the NIC can be split into a plurality of strides of MTU fixed size and each WQE of the plurality of WQEs can reference a different stride of the plurality of strides.

Posting the plurality of WQEs in the RQ of the GPU can comprise locking the RQ of the GPU, creating the plurality of WQEs in the RQ of the GPU based on the received plurality of packets, issuing a memory barrier instruction for a doorbell record of the NIC, updating the doorbell record of the NIC based on the created plurality of WQEs, and unlocking the RQ of the GPU.

Polling, in parallel, the plurality of CQEs from the CQ of the GPU can comprise locking the CQ of the GPU and storing data from each CQE of the plurality of CQEs to memory of the GPU. Storing data from each CQE of the plurality of CQEs to memory of the GPU can comprise reading an index for the plurality of CQEs and checking data of a CQE of the plurality of CQEs corresponding to the index for errors. In response to the data of the CQE of the plurality of CQEs corresponding to the index being error free, the data of the CQE of the plurality of CQEs corresponding to the index can be stored in the memory of the GPU and the index of the plurality of CQEs can be incremented. Polling the plurality of CQEs from the CQ of the GPU can then further comprise issuing a memory barrier instruction for a doorbell record of the NIC, updating the doorbell record of the NIC, and unlocking the CQ of the GPU.

### BRIEF DESCRIPTION OF THE SEVERAL VIEWS OF THE DRAWINGS

The present disclosure is described in conjunction with the appended figures, which are not necessarily drawn to scale.

FIG. 1 is a block diagram illustrating an exemplary environment in which embodiments of the present disclosure can be implemented.

FIG. 2 is a block diagram illustrating a correspondence between request queues, completion queues, and memory according to one embodiment of the present disclosure.

FIG. 3 is a flowchart illustrating an exemplary process for parallel processing of network communications according to one embodiment of the present disclosure.

FIG. 4 is a flowchart illustrating additional details of an exemplary process for polling of completion queue entries according to one embodiment of the present disclosure.

FIG. 5 is a flowchart illustrating additional details of an exemplary process for storing data to memory according to one embodiment of the present disclosure.

### DETAILED DESCRIPTION

The ensuing description provides embodiments only, and is not intended to limit the scope, applicability, or configuration of the claims. Rather, the ensuing description will provide those skilled in the art with an enabling description for implementing the described embodiments. It is understood that various changes may be made in the function and arrangement of elements without departing from the spirit and scope of the appended claims.

It will be appreciated from the following description, and for reasons of computational efficiency, that the components of the system can be arranged at any appropriate location within a distributed network of components without impacting the operation of the system.

Furthermore, it should be appreciated that the various links connecting the elements can be wired, traces, or wireless links, or any appropriate combination thereof, or any other appropriate known or later developed element(s) that is capable of supplying and/or communicating data to and from the connected elements. Transmission media used as links, for example, can be any appropriate carrier for electrical signals, including coaxial cables, copper wire and fiber optics, electrical traces on a printed circuit board (PCB), or the like.

As used herein, the phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “automatic” and variations thereof, as used herein, refers to any appropriate process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not to be deemed “material.”

The terms “determine,” “calculate,” and “compute,” and variations thereof, as used herein, are used interchangeably, and include any appropriate type of methodology, process, operation, or technique.

Various aspects of the present disclosure will be described herein with reference to drawings that are schematic illustrations of idealized configurations.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and this disclosure.

As used herein, the singular forms “a,” “an,” and “the” are intended to include the plural forms as well, unless the context clearly indicates otherwise. It will be further understood that the terms “comprise,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. The term “and/or” includes any and all combinations of one or more of the associated listed items.

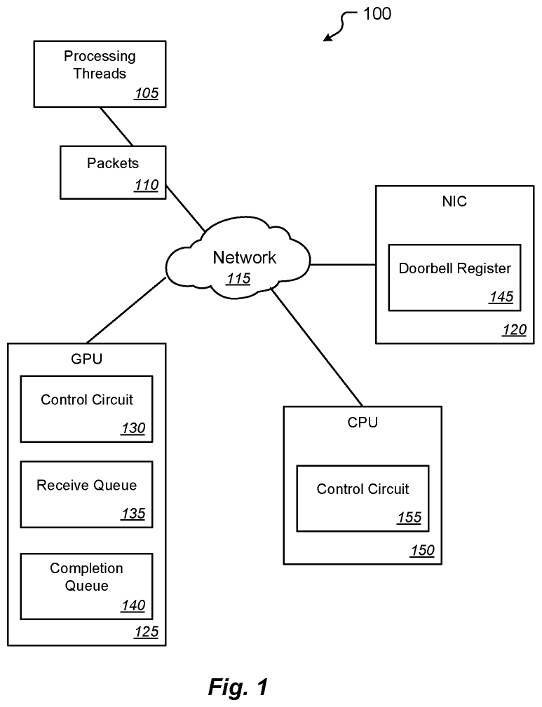

Referring now to FIGS. 1-5, various systems and methods for parallel processing of network communications on devices supporting a high degree of parallelization, such as a Graphics processing unit (GPU) will be described. Generally speaking, embodiments of the present disclosure are directed to an inline packet processing pipeline to receive packets in GPU memory without staging copies through Central Processing Unit (CPU) memory, process the received packets in parallel with one or more kernels of the GPU, and then run inference, evaluate, or send over the network the result of the calculation. In this way, the highly parallel nature of the GPU can be leveraged to process network communications without involving other elements of the system, such as the CPU, which can be quickly consumed with processing network communications to the detriment of other processes.

FIG. 1 is a block diagram illustrating an exemplary environment in which embodiments of the present disclosure can be implemented. As illustrated in this example, the environment 100 can comprise a number of processing threads 105 executing in parallel on one or more elements (not shown herein) of the environment 100. These threads can comprise, for example, one or more CUDA threads executing on any of a variety of generic endpoints within the environment 100. The processing threads 105 can send a plurality of packets 110 across a communications network 115 such as, for example, an Ethernet network. For example, the packets 110 can be received by a Network Interface Controller (NIC) for routing to other elements of the environment 100 as known in the art. The environment 100 can also include a GPU 125. The GPU 125 can comprise a control circuit 130 controlling operation of the GPU 125. The control circuit 130 comprise a Central Processing Unit (CPU) 150 further comprising a control circuit 155, e.g., one or more microprocessors, or similar components as known in the art.

As introduced above, embodiments are directed to utilizing the GPU to process the data packets 110 in parallel without intervention of other components of the environment 100. To do so, the control circuit 155 of the CPU 150 can cause the CPU 150 to receive, from the NIC 120, through the communication network 115, the plurality of data packets 110. The control circuit 155 can further cause the CPU 150 to post, in a Receive Queue (RQ) 135 of the GPU 125, a plurality of Work Queue Entries (WQEs), each WQE of the plurality of WQEs corresponding to a packet of the received plurality of packets, and poll, in parallel, a plurality of Completion Queue Entries (CQEs) from a Completion Queue (CQ) 140 of the GPU 125, each CQE of the plurality of CQEs corresponding to a WQE of the plurality of WQEs.

For example, the GPU 125 can utilize an NVIDIA DOCA GPUNetIO library with modified GPU receive operations capable of receiving in parallel, for a given number of nanoseconds, several packets at the same time exploring the potentiality of multiple CUDA kernels collaborating on the same receive queue.

Typically, in the MLX5 protocol the application (either CPU or GPU) repeats the previous steps every time a new set of packets is to be received. The creation of a receive WQE implies to create a new 16B descriptor in the RQ memory having the following info about the memory area where a packet should be received: memory key (mkey), address and number of bytes.

In Ethernet communications, an application is expected to receive packets with a maximum size of the Maximum Transmission Unit (MTU) set on the interface. Additionally, the memory key associated to each WQE can be the same if it refers to the same memory area allocated and mapped to receive multiple packets.

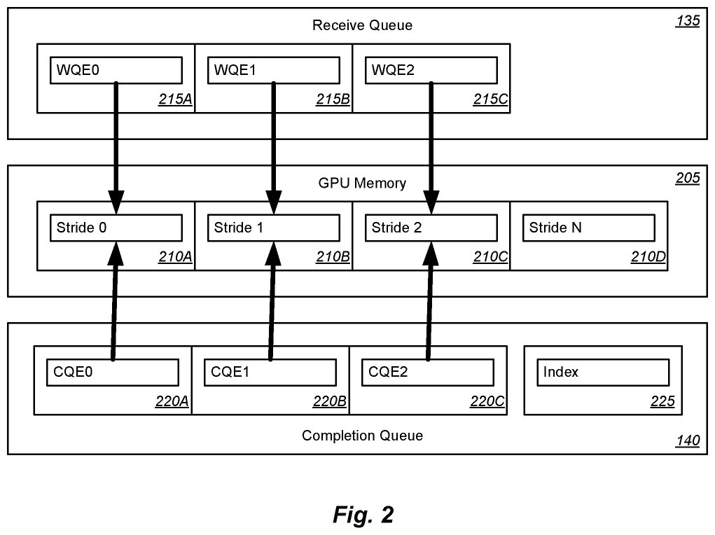

FIG. 2 is a block diagram illustrating a correspondence between request queues, completion queues, and memory according to one embodiment of the present disclosure. As illustrated here, the memory of the GPU 125 can comprise a pre-allocated portion of memory 205 mapped to the NIC 120. The pre-allocated portion of memory 205 mapped to the NIC 120 can be split into a plurality of strides 210A-210D of MTU fixed size. Each WQE of the plurality of WQEs 215A-215C in the RQ 135 can reference a different stride of the plurality of strides 210A-210C.

By pre-allocating a large portion of GPU memory and mapping it to the NIC 120, e.g., by using a single mkey for the whole memory area, and splitting this memory 205 into multiple strides 210A-210D of MTU fixed side, it is possible to pre-post from the CPU, only once at the beginning (setup phase) all the WQEs 215A-215C in the RQ 135, connecting each WQE mkey, address and size to a different stride 210A-210C of the same GPU memory chunk.

This queue structure doesn't require any WQE update at runtime when receiving packets from a CUDA kernel as each WQE 215A-215C is already posted and connected to the same GPU memory stride 210A-210C. The only operation that must be done at runtime by the GPU is the updating of the doorbell record 145 of the NIC 120, to communicate from the application to the NIC 120 what is the next available WQE to use to receive new packets.

The MLX5 protocol provides that for X consecutive receive WQEs 215A-215C, X consecutive CQEs 220A-220C are posted in the CQ 140 if X packets are received by the NIC 120. As an example, if the RQ 135 has 5 WQEs (WQE0, . . . , WQE4) posted and 5 packets are received with those WQEs, in the CQ 5 CQEs will be created (CQE0, . . . , CQE4) without any “empty space” between CQEs.

When executing this algorithm in a CUDA kernel, operations can be parallelized, i.e., multiple CUDA threads (at CUDA block or CUDA warp level) can poll in parallel different CQEs in different positions. DOCA GPUNetIO can provide a parallelized receive function a CUDA kernel can invoke to poll multiple CQEs from different CUDA threads for a given number of nanoseconds. Specifically, the receive function can be invoked by all the threads in a CUDA block or in a CUDA warp.

Combining the assumption of consecutive CQEs for consecutive received packets and that every packet is received in the next stride of the GPU memory receive buffer, the function can return the first stride id used to receive the first packet and the number of packets received during the receive function execution.

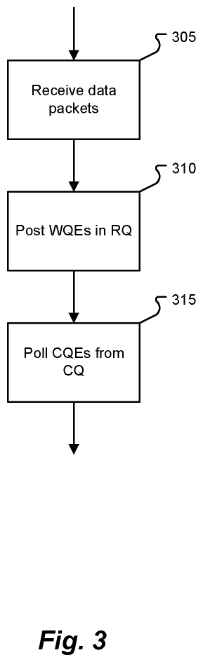

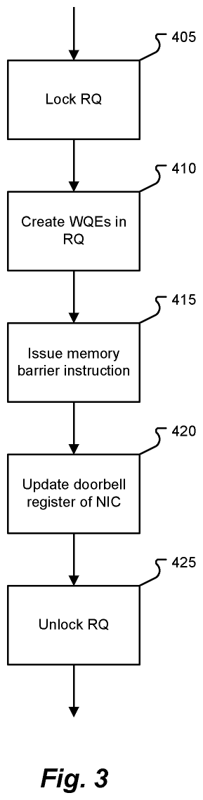

FIG. 3 is a flowchart illustrating an exemplary process for parallel processing of network communications according to one embodiment of the present disclosure. As illustrated in this example, parallel processing of network communications as can be performed by a CPU 150 as described above can comprise receiving 305, by a CPU 150, a plurality of data packets 110 from a NIC 120 through a network 115. As noted, the network 110 can comprise, for example, an Ethernet network. A plurality of WQEs 215A-215C can be posted 310 in a RQ 135 of the GPU 125. Each WQE of the plurality of WQEs 215A-215C can correspond to a packet of the received 305 plurality of packets 110. Additional details of an exemplary process for posting 310 the plurality of WQEs 215A-215C in the RQ 135 of the GPU 125 will be described below with reference to FIG. 4.

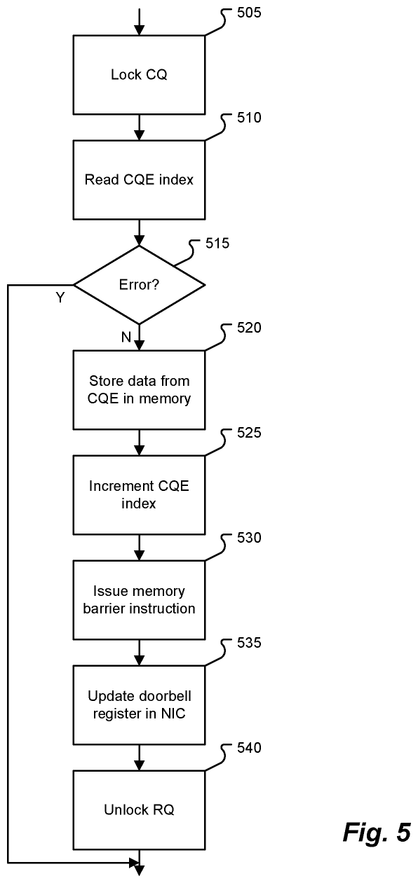

A plurality of CQEs 220A-220C can be polled 315 from a CQ 140 of the CPU 150. Each CQE of the plurality of CQEs 220A-220C can correspond to a WQE of the plurality of WQEs 215A-215C. Polling 315 the plurality of CQEs 220A-220C from the CQ 140 of the GPU 125 can comprise polling in parallel a plurality of CQEs from each of a plurality of executing threads 105. Additional details of an exemplary process for polling 315 the plurality of CQEs 220A-220C from the CQ 140 of the GPU 125 will be described below with reference to FIG. 5.

FIG. 4 is a flowchart illustrating additional details of an exemplary process for polling of completion queue entries according to one embodiment of the present disclosure. As illustrated in this example, posting the plurality of WQEs 215A-215C in the RQ 135 of the GPU 125 as can be performed by the CPU 150 as described above can comprise optionally locking 405 the RQ 135 of the GPU 125. The plurality of WQEs 215A-215C can be created 410 in the RQ 135 of the GPU 125 based on the received plurality of packets 110. A memory barrier instruction can be issued 415 for a doorbell record 145 of the NIC 120. The doorbell record 145 of the NIC 120 can then be updated 420 based on the created 410 plurality of WQEs 215A-215C and the RQ 135 of the GPU 125 can be unlocked 425, if previously locked 405. It should be noted that locking the RQ can be logically correct per CUDA block or CUDA warp but explicitly locking 405 and unlocking 425 the RQ need not be performed through lock/unlock instruction. Rather, it enough for the application to assign RQ0 to CUDA Block 0, RQ1 to CUDA block 1 and so on.

FIG. 5 is a flowchart illustrating additional details of an exemplary process for storing data to memory according to one embodiment of the present disclosure. As illustrated in this example, polling the plurality of CQEs 220A-220C from the CQ 140 of the GPU 125 in parallel as my be performed by the CPU 150 as described above can comprise locking 605 the CQ 140 of the GPU 125 and storing data from each CQE of the plurality of CQEs 220A-220C to memory 205 of the GPU 125. Storing data from each CQE of the plurality of CQEs 220A-220C to memory 205 of the GPU 125 can comprise reading 510 an index 225 for the plurality of CQEs 220A-220C and checking 515 data of a CQE of the plurality of CQEs 220A-220C corresponding to the index 225 for errors. In response to determining 515 the data of the CQE of the plurality of CQEs 220A-220C corresponding to the index 225 is error free, the data of the CQE of the plurality of CQEs 220A-220C corresponding to the index 225 can be stored 520 in the memory 205 of the GPU 125 and the index 225 of the plurality of CQEs 220A-220C can be incremented 525. Polling the plurality of CQEs 220A-220C from the CQ 140 of the GPU 125 can then further comprise issuing 530 a memory barrier instruction for a doorbell record 145 of the NIC 120, updating 535 the doorbell record 145 of the NIC 120, and unlocking 540 the CQ 140 of the GPU 125.

It should be noted that numerous variations in the structure, function, order of operations, and/or other aspects of the various embodiments described herein are contemplated. The operations described above for exemplary processes for synchronizing clocks between computing devices can be performed in different order and each operation need not depend on a prior event or operation. For example, the sending of synchronization messages can be initiated by any device at any time and does not need to happen in response to those events receiving a synchronization message or other event. Also, the process for setting the clock does not need to be executed in response to completing the dialogs. For example, the task of measuring the clock offset can be performed in one process while the task of setting the clock based on the clock offset could be done in the second process that functions asynchronously relative to the first process. Other such variations are further contemplated and are considered to be within the scope of the present disclosure.

The present disclosure, in various aspects, embodiments, and/or configurations, includes components, methods, processes, systems, and/or apparatus substantially as depicted and described herein, including various aspects, embodiments, configurations embodiments, sub-combinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and\or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A Central Processing Unit (CPU) comprising:
a control circuit controlling operation of the CPU, wherein the control circuit causes the CPU to:
receive, from a Network Interface Card (NIC), through a communication network, a plurality of data packets;
post in a Receive Queue (RQ) of a Graphics Processing Unit (GPU) a plurality of Work Queue Entries (WQEs), each WQE of the plurality of WQEs corresponding to a packet of the received plurality of packets; and
poll, in parallel, a plurality of Completion Queue Entries (CQEs) from a Completion Queue (CQ) of the GPU, each CQE of the plurality of CQEs corresponding to a WQE of the plurality of WQEs.

2. The CPU of claim 1, wherein posting the plurality of WQEs in the RQ of the GPU comprises:
creating the plurality of WQEs in the RQ of the GPU based on the received plurality of packets;
issuing a memory barrier instruction for a doorbell record of the NIC; and
updating the doorbell record of the NIC based on the created plurality of WQEs.

3. The CPU of claim 2, wherein the memory of the GPU comprises a pre-allocated portion of memory mapped to the NIC, wherein the pre-allocated portion of memory mapped to the NIC is split into a plurality of strides of Maximum Transmission Unit (MTU) fixed size, and wherein each WQE of the plurality of WQEs references a different stride of the plurality of strides.

4. The CPU of claim 1, wherein polling, in parallel, the plurality of CQEs from the CQ of the GPU comprises:
locking the CQ of the GPU;
storing data from each CQE of the plurality of CQEs to memory of the GPU;
issuing a memory barrier instruction for a doorbell record of the NIC;
updating the doorbell record of the NIC; and
unlocking the CQ of the GPU.

5. The CPU of claim 4, wherein storing data from each CQE of the plurality of CQEs to memory of the GPU comprises:
reading an index for the plurality of CQEs;
checking data of a CQE of the plurality of CQEs corresponding to the index for errors;
in response to the data of the CQE of the plurality of CQEs corresponding to the index being error free, storing the data of the CQE of the plurality of CQEs corresponding to the index in the memory of the GPU; and
incrementing the index of the plurality of CQEs.

6. The CPU of claim 4, wherein polling, in parallel, the plurality of CQEs from the CQ of the GPU comprises polling a plurality of CQEs from each of a plurality of executing threads.

7. The CPU of claim 1, wherein the communication network comprises an Ethernet network.

8. A system comprising:
a communication network;
a Network Interface Card (NIC) coupled with the communications network;
a Graphics Processing Unit (GPU) coupled with the communications network; and
a Central Processing Unit (CPU) coupled with the communications network, the CPU comprising control circuit controlling operation of the CPU, wherein the control circuit causes the CPU to:
receive, from the NIC, through the communication network, a plurality of data packets;
post in a Receive Queue (RQ) of the GPU a plurality of Work Queue Entries (WQEs), each WQE of the plurality of WQEs corresponding to a packet of the received plurality of packets; and
poll, in parallel, a plurality of Completion Queue Entries (CQEs) from a Completion Queue (CQ) of the GPU, each CQE of the plurality of CQEs corresponding to a WQE of the plurality of WQEs.

9. The system of claim 8, wherein posting the plurality of WQEs in the RQ of the GPU comprises:
creating the plurality of WQEs in the RQ of the GPU based on the received plurality of packets;
issuing a memory barrier instruction for a doorbell record of the NIC; and
updating the doorbell record of the NIC based on the created plurality of WQEs.

10. The system of claim 9, wherein the memory of the GPU comprises a pre-allocated portion of memory mapped to the NIC, wherein the pre-allocated portion of memory mapped to the NIC is split into a plurality of strides of Maximum Transmission Unit (MTU) fixed size, and wherein each WQE of the plurality of WQEs references a different stride of the plurality of strides.

11. The system of claim 8, wherein polling, in parallel, the plurality of CQEs from the CQ of the GPU comprises:
locking the CQ of the GPU;
storing data from each CQE of the plurality of CQEs to memory of the GPU;
issuing a memory barrier instruction for a doorbell record of the NIC;
updating the doorbell record of the NIC; and
unlocking the CQ of the GPU.

12. The system of claim 11, wherein storing data from each CQE of the plurality of CQEs to memory of the GPU comprises:
reading an index for the plurality of CQEs;
checking data of a CQE of the plurality of CQEs corresponding to the index for errors;
in response to the data of the CQE of the plurality of CQEs corresponding to the index being error free, storing the data of the CQE of the plurality of CQEs corresponding to the index in the memory of the GPU; and
incrementing the index of the plurality of CQEs.

13. The system of claim 11, wherein polling, in parallel, the plurality of CQEs from the CQ of the GPU comprises polling a plurality of CQEs from each of a plurality of executing threads.

14. The system of claim 8, wherein the communication network comprises an Ethernet network.

15. A method for parallel processing of network communications, the method comprising:
receiving, by a control circuit of a Central Processing Unit (CPU), from a Network Interface Card (NIC), through an Ethernet network, a plurality of data packets;
posting, by the control circuit of the CPU, in a Receive Queue (RQ) of a Graphics Processing Unit (GPU), a plurality of Work Queue Entries (WQEs), each WQE of the plurality of WQEs corresponding to a packet of the received plurality of packets; and
polling, by the control circuit of the CPU, in parallel, a plurality of Completion Queue Entries (CQEs) from a Completion Queue (CQ) of the GPU, each CQE of the plurality of CQEs corresponding to a WQE of the plurality of WQEs.

16. The method of claim 15, wherein posting the plurality of WQEs in the RQ of the GPU comprises:
creating the plurality of WQEs in the RQ of the GPU based on the received plurality of packets;
issuing a memory barrier instruction for a doorbell record of the NIC; and
updating the doorbell record of the NIC based on the created plurality of WQEs.

17. The method of claim 16, wherein the memory of the GPU comprises a pre-allocated portion of memory mapped to the NIC, wherein the pre-allocated portion of memory mapped to the NIC is split into a plurality of strides of Maximum Transmission Unit (MTU) fixed size, and wherein each WQE of the plurality of WQEs references a different stride of the plurality of strides.

18. The method of claim 15, wherein polling, in parallel, the plurality of CQEs from the CQ of the GPU comprises:
locking the CQ of the GPU;
storing data from each CQE of the plurality of CQEs to memory of the GPU;
issuing a memory barrier instruction for a doorbell record of the NIC;
updating the doorbell record of the NIC; and
unlocking the CQ of the GPU.

19. The method of claim 18, wherein storing data from each CQE of the plurality of CQEs to memory of the GPU comprises:
reading an index for the plurality of CQEs;
checking data of a CQE of the plurality of CQEs corresponding to the index for errors;
in response to the data of the CQE of the plurality of CQEs corresponding to the index being error free, storing the data of the CQE of the plurality of CQEs corresponding to the index in the memory of the GPU; and
incrementing the index of the plurality of CQEs.

20. The method of claim 18, wherein polling, in parallel, the plurality of CQEs from the CQ of the GPU comprises polling a plurality of CQEs from each of a plurality of executing threads.
